(19) United States
(12) Patent Application Publication
(10) Pub. No.: US 2017/0031896 A1
(43) Pub. Date: Feb. 2, 2017

(54) ROBUST REVERSIBLE FINITE-STATE APPROACH TO CONTEXTUAL GENERATION AND SEMANTIC PARSING

(71) Applicant: Xerox Corporation, Norwalk, CT (US)

(72) Inventors: Marc Dymetman, Grenoble (FR); Sriram Venkatapathy, Grenoble (FR); Chunyang Xiao, Grenoble (FR)

(73) Assignee: Xerox Corporation, Norwalk, CT (US)

(21) Appl. No.: 14/811,005

(22) Filed: Jul. 28, 2015

(51) Int. Cl. G06F 17/27; G06F 17/28

(52) U.S. Cl. CPC G06F 17/2715; G06F 17/274; G06F 17/279; G06F 17/28

(57) ABSTRACT

A system and method permit analysis and generation to be performed with the same reversible probabilistic model. The model includes a set of factors, including a canonical factor, which is a function of a logical form and a realization thereof, a similarity factor, which is a function of a canonical text string and a surface string, a language model factor, which is a static function of a surface string, a language context factor, which is a dynamic function of a surface string, and a semantic context factor, which is a dynamic function of a logical form. When performing generation, the canonical factor, similarity factor, language model factor, and language context factor are composed to receive as input a logical form and output a surface string, and when performing analysis, the similarity factor, canonical factor, and semantic context factor are composed to take as input a surface string and output a logical form.

### BACKGROUND

The exemplary embodiment relates to reversible systems for natural language generation and analysis and finds particular application in dialog systems which interact between a customer and a virtual agent.

Dialog systems enable a user, such as a customer, to communicate with a virtual agent in natural language form, such as through textual or spoken utterances. Such systems may be used for a variety of tasks, such as for addressing questions that the user may have in relation to a device or service e.g., via an online chat service, and for transactional applications, where the virtual agent collects information from the customer for completing a transaction.

In the field of natural language processing of dialogue, “generation” refers to the process of mapping a logical form z into a textual utterance x (e.g., for output by a virtual agent) while “analysis” is the reverse process: mapping a textual utterance x (e.g., received from a customer) to a logical form z. While the two processes are generally modeled through independent specifications, there are advantages to viewing them as two modes of a single so-called “reversible” specification.

Traditional approaches to reversibility have focused on non-statistical unification grammars, namely grammatical specifications of the relation between logical forms for sentences and their textual realizations which could be used indifferently for generation or for parsing. See, e.g., Dymetman, et al., “Reversible logic grammars for machine translation,” Proc. 2nd Int'l Conf. on Theoretical and Methodological Issues in Machine Translation of Natural Languages, 1988; van Noord, “Reversible unification based machine translation,” Proc. 13th Conf. on Computational Linguistics (COLING '90), Vol. 2, pp. 299-304, 1990; and Reversible Grammar in Natural Language Processing, T. Strzalkowski, Ed., Springer, 1994. These are non-statistical methods. According to such approaches, translating a French sentence into an English sentence can be decomposed into parsing the French sentence into some logical form and generating the English sentence from this logical form. Translating an English sentence into French is the reverse process. It was anticipated that providing only one specification (i.e., a reversible grammar) for the relation between English (resp. French) sentences and logical forms would save significant development effort. However, one problem exists with reversible grammars. The reversible grammar specifies a logical relation r(x,z), with parsing being the problem of finding, for an input x, some z subject to r(x,z), and generation being the symmetrical problem. It has proved, however, difficult to specify an r that has exactly the right coverage: on one hand, r(x,z) should be robust in parsing, that is, to accept a large number of possible strings x (even those that may be unexpected or non-grammatical), and on the other hand, when used for generation, the strings x associated with a given z should be linguistically correct. This is in contrast to conventional non-reversible approaches in which the generation grammar can concentrate on producing a few possible correct realizations for each logical form, while the parsing grammar can incorporate some (but limited) tolerance to ill-formed inputs.

### INCORPORATION BY REFERENCE

The following references, the disclosures of which are incorporated by reference in their entireties, are mentioned:

U.S. application Ser. No. ______, filed contemporaneously herewith, entitled LEARNING GENERATION TEMPLATES FROM DIALOG TRANSCRIPTS, by Sriram Venkatapathy, Shachar Mirkin, and Marc Dymetman.

### BRIEF DESCRIPTION

In accordance with one aspect of the exemplary embodiment, a method providing for analysis and generation through a same probabilistic model. The method includes providing a reversible probabilistic model which includes a set of factors. The factors include a canonical factor which is a function of a logical form and a realization, a similarity factor, which is a function of a canonical text string and a surface string, a language model factor, which is a static function of a surface string, a language context factor, which is a dynamic function of a surface string, and a semantic context factor, which is a dynamic function of a logical form. The reversible probabilistic model is able to perform both analysis and generation. In performing generation, the canonical factor, similarity factor, language model factor, and language context factor are composed to receive as input a logical form selected from a set of logical forms and output at least one surface string. In performing analysis, the similarity factor, canonical factor, and semantic context factor are composed to take as input a surface string and output at least one logical form in a set of logical forms.

The performing of the analysis and generation may be implemented by a processor.

In accordance with another aspect of the exemplary embodiment, a system for performing analysis and generation includes memory which stores a reversible probabilistic model. The model includes a set finite state machines including a canonical finite state machine, which is a function of a logical form and a canonical text string which is a realization of the logical form, a similarity finite state machine, which is a function of a canonical text string and a surface string, a language model finite state machine which is a static function of a surface string, a language context finite state machine, which is a dynamic function of a surface string, and a semantic context finite state machine, which is a dynamic function of a logical form. A dialog manager inputs logical forms and surface strings to the reversible probabilistic model for performing analysis and generation. In performing generation, the canonical finite state machine, similarity finite state machine, language model finite state machine, and language context finite state machine of the reversible probabilistic model are composed to receive as input a logical form selected from a set of logical forms and output at least one surface string. In performing analysis, the similarity finite state machine, canonical finite state machine, and semantic context finite state machine of the reversible probabilistic model are composed to take as input a surface string and output at least one of the logical forms in the set of logical forms. A processor implements the dialog manager.

In accordance with another aspect of the exemplary embodiment, a computer implemented method for conducting a dialogue. The method includes providing, in computer memory, a reversible probabilistic model able to perform both analysis and generation, the reversible probabilistic model comprising a set of finite state machines including a canonical finite state machine, which is a function of a logical form and a canonical text string which is a realization of the logical form, a similarity finite state machine, which is a function of a canonical text string and a surface string, a language model finite state machine which is a static function of a surface string, a language context finite state machine, which is a dynamic function of a surface string, and a semantic context finite state machine, which is a dynamic function of a logical form. A surface text string uttered by a person is received. The received surface text string is analyzed. In the analysis, the similarity factor, canonical factor, and semantic context factor are composed to take as input the surface string and output a first of a set of logical forms. A second logical form is selected, based on the first logical form. At least one surface string is generated. In the generation, the canonical factor, similarity factor, language model factor, and language context factor are composed to receive as input the second logical form and output the at least one surface string. One of the at least one surface string (or a surface string derived therefrom) is output for communication to the person on a computing device. The analyzing and generation may be implemented by a processor.

### BRIEF DESCRIPTION OF THE DRAWINGS

FIG. 1 is a functional block diagram of a system for natural language analysis and generation in accordance with one aspect of the exemplary embodiment;

FIG. 2 is a flow chart illustrating a method for natural language analysis and generation in accordance with one aspect of the exemplary embodiment;

FIG. 3 graphically illustrates a reversibility model used in the system of FIG. 1;

FIG. 4 illustrates the components of the model of FIG. 3 that are used for analysis (parsing);

FIG. 5 illustrates the components of the model of FIG. 3 that are used for generation;

FIG. 6 illustrates an exemplary canonical factor implemented as a string-to-string transducer;

FIG. 7 illustrates an exemplary semantic context factor implemented as an automaton with equal probabilities;

FIG. 8 illustrates another exemplary semantic context factor implemented as another automaton, equivalent to the automaton of FIG. 7 when composed with the transducer of FIG. 6;

FIG. 9 illustrates an exemplary semantic context factor automaton respecting the constraint that two valid symbol sequences representing the same logical form have the same weight;

FIG. 10 illustrates an exemplary similarity factor string-to-string transducer;

FIG. 11 illustrates an exemplary semantic context automaton;

FIG. 12 illustrates an automaton αₓ_{₀} that is the composition of the automaton of FIG. 11 with similarity and canonical automatons;

FIG. 13 illustrates the best path in the automaton of FIG. 12;

FIG. 14 illustrates another automaton αₓ_{₀};

FIG. 15 illustrates the best path illustrates the best path in the automaton of FIG. 14;

FIG. 16 illustrates yet another composed automaton αₓ_{₀};

FIG. 17 illustrates the best path in the automaton of FIG. 16;

FIG. 18 illustrates another exemplary semantic context automaton;

FIG. 19 illustrates a composed automaton αₓ_{₀} generated based on the automaton of FIG. 18; and

FIG. 20 illustrates the best path in the automaton of FIG. 19.

### DETAILED DESCRIPTION

Aspects of the exemplary embodiment relate to system and method which employ a reversible formalism for natural language generation and analysis (parsing) based on weighted finite-state automata and transducers. In generation, the input is a logical form and the output received from the model is an automaton that represents a distribution over textual realizations. From this automaton, either the most probable textual realization is retrieved or a sample of realizations is produced, according to the distribution. In parsing, the input is text or a textual representation of a spoken utterance and the output received is an automaton that represents a distribution over logical forms. From this automaton, either the most probable logical form is retrieved or a sample of logical forms according to the distribution is produced. The formalism allows dynamically defining of contextual expectations over logical forms or over realizations, which is useful for applications such as dialogue. The system and method provide robust semantic parsing through the introduction of a similarity transducer that allows actual texts, which can be very variable, to be related to canonical realizations that can be seen as prototypical textual renderings of the logical forms. The generation and analysis can be defined conceptually using automata and transducers over both strings and trees. In one embodiment, logical forms (which should be trees) are emulated by strings, which facilitates use of toolkits which operate on strings, such as the open source toolkit OpenFST.

In existing non-weighted (i.e., non-probabilistic) reversible systems, anything that can be parsed could be generated, and there has been no way to evaluate the qualities of different proposed outputs. The exemplary probabilistic method and system described herein are robust to many possible text inputs, even deviant ones, while favoring the generation of well-formed realizations rather than ill-formed ones. The framework for reversibility resolves the conflict between getting a robust semantic parser on the one hand, and getting a linguistically correct generator on the other hand.

In the reversible framework, parsing and generation are seen as dual conditionalizations of a common probabilistic graphical model. The factors of the graphical model are implemented through weighted finite-state automata and transducers. Finite-state transducers are inherently able to be conditioned on either input or output and thus represent a suitable formalism for implementing reversibility. They also allow marginalization to be computed efficiently through finite-state composition, a property that is useful for handling latent variables in the model.

The modularization of the probabilistic model into a set of factors allows some of the factors to be dynamic, so that they can updated, while others remain static throughout a dialogue. When a dynamic factor is updated, the probability distribution of its output for at least one given input is modified (while some are unchanged). A static factor does not change over the dialogue so that for any given input, the respective probability distribution of the output remains the same.

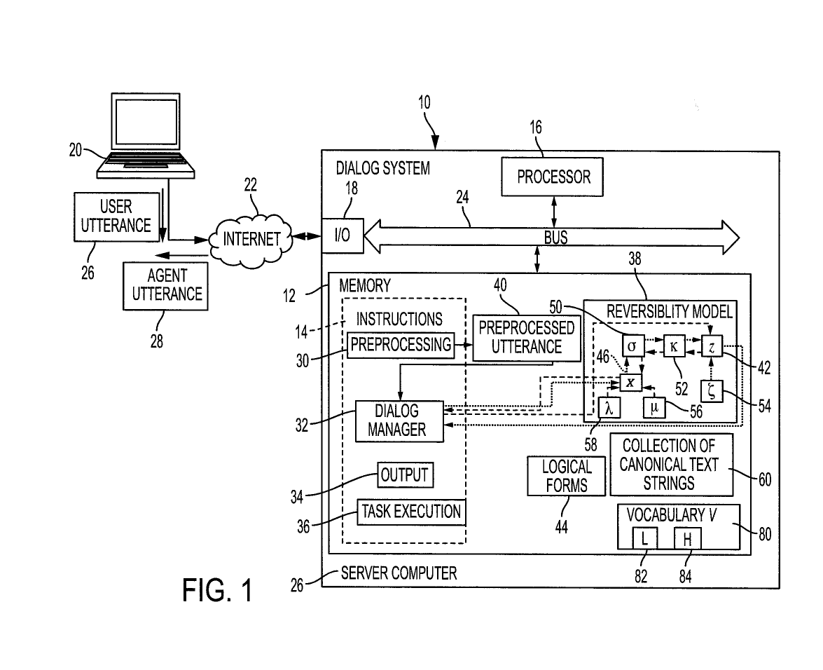

With reference to FIG. 1, a functional block diagram of a computer-implemented system 10 for natural language analysis and generation is shown. The exemplary system is described in the context of a task-oriented dialog system which is designed for conversing with a human, however other applications are contemplated.

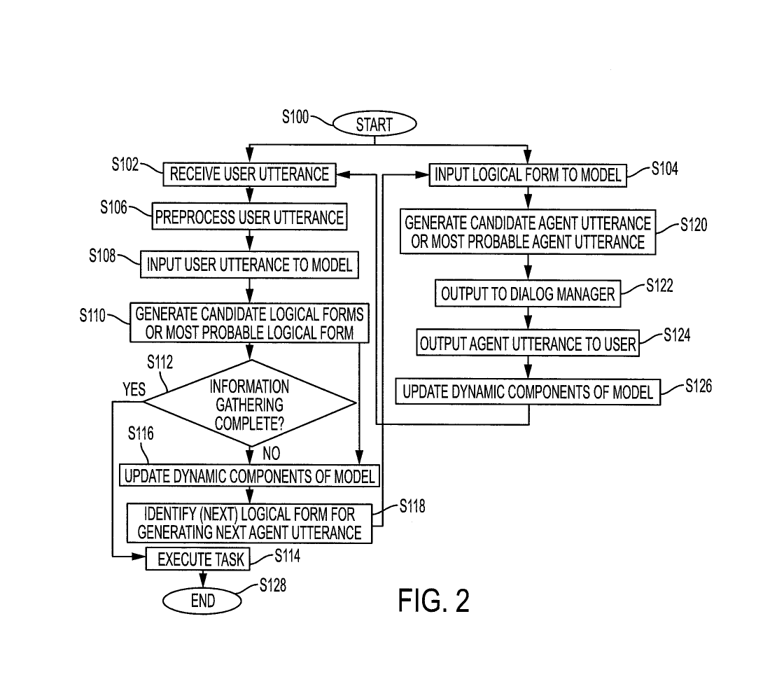

The illustrated system 10 includes memory 12 which stores instructions 14 for performing the method illustrated in FIG. 2 and a processor 16 in communication with the memory for executing the instructions. The system 10 also includes one or more input/output (I/O) devices, such as a network interface 18 for communicating with external devices, such as the illustrated client device 20, e.g., via a wired or wireless link 22 such as the Internet. The various hardware components 12, 16, 18 of the system 10 may be all connected by a data/control bus 24.

The system 10 receives, as input, utterances 26 from a user, such as a customer or other person, which may be textual or spoken. The system outputs utterances 28, referred to as agent utterances. The agent utterances 28 may be generated fully automatically or may be supervised by a human agent. In illustrative embodiments, the utterances are each a text string, i.e., a sequence of words in a natural language having a grammar, such as English or French.

The illustrated instructions include a preprocessing component 30, a dialog manager 32, an output component 34, and optionally an execution component 36. As will be appreciated, there may be other components of such a system, depending on the application, which are not considered here. Memory also stores a reversible model 38, which performs both analysis and generation functions.

The preprocessing component 30 preprocesses each input user utterance 26 to generate a preprocessed utterance 40. The level of preprocessing may depend in part on the form of the user utterance and the configuration of the system. In the case of text utterances, the preprocessing component may perform tokenization to convert the input text string into a sequence of tokens, which are primarily words but may also include numbers and parts of speech. Words may be lemmatized (e.g., converting plural to singular, verbs to their infinitive form, etc.). In the case of spoken utterances, the preprocessing may include speech to text conversion, which may result in the generation of a weighted lattice of possible words composing the utterance, which may be instantiated as a weighted finite state automaton.

The dialog manager 32 is a component that manages the state of the dialog, and dialog strategy. The dialog manager may maintain a set of state variables, such as the dialog history, the latest unanswered question, information needed, etc., depending on the system. The dialog manager interfaces with the reversible model 38. In particular, the preprocessed user utterance 40 is input by the dialog manager to the model 38 for analysis and output of a first one or more candidate logical forms 42 from a predefined set 44 of logical forms. In a reverse path, a second logical form 42, selected from the same or a different set 44 of logical forms by the dialog manager, is input to the reversible model 38 for generating one or more candidate agent utterances 46 (in some embodiments, a single utterance, in other embodiments, a distribution over utterances 46). The dialog manager 32 may select one of the candidate utterances 46 as the virtual agent utterance.

During a dialogue, the second logical form selected for the reverse path may depend on the first logical form previously identified for a customer utterance (if any) and/or on the stored state of the dialogue. In particular, the dialogue manager may modify its internal state based on the recognized first logical form and select a second logical form depending on what further information is determined to be needed and inputs this to the model. In some embodiments, when the dialog system 32 wishes to clarify what the customer has uttered, the generation step may include using the first logical form as the second logical form, and effectively regenerating a sentence which is expected to match the meaning of the customer utterance, even if it does not use exactly the same words. This may be embedded in a sentence such as This is what I understood you said . . . is this correct?

The output component 34 outputs an agent utterance 28 received from the dialog manager, which is sent to the user's device 20 or to a human agent for verification.

When the dialogue system has gathered information from the dialogue, the execution component 36 may perform a task, depending on the type of dialog system, such as retrieve information from a knowledge base that is responsive to what the system has understood from the user's utterances, complete a transaction, such as a customer purchase of a product or service, or the like. In some embodiments, the system 10 is used for machine translation, in which case, the output utterances 28 may be in a different language from the input utterances 26.

The reversibility model 38 includes a set of finite state devices 50, 52, 54, 56, 58, two of which are used for both analysis and generation (50, 52), and some of which are only used for generation (56, 58), or only used for analysis (54).

Memory 12 also stores, for each of the set 44 of logical forms, a collection 60 of canonical text strings. Each canonical text string is composed of a sequence of words (or more generally, tokens) in the natural language which obeys the grammar of the natural language.

The computer system 10 may include one or more computing devices 26, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data.

The network interface 18 allows the computer to communicate with other devices via a computer network, such as a local area network (LAN) or wide area network (WAN), or the internet, and may comprise a modulator/demodulator (MODEM) a router, a cable, and and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 26.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 2 illustrate a method for natural language analysis and generation, which may be performed with the system of FIG. 1. The method begins at S100. The method assumes that a model has been provided in which the factors are implemented by finite state machines.

Depending on the application, the method may proceed to S102 or to S104.

At S102, a user utterance 26 (spoken or textual) is received. In some embodiments, the text string may be natural language processed to lemmatize words and/or identify morphological forms of words.

At S106, the utterance may be preprocessed to identify a sequence of tokens, optionally with alternatives when the system is unsure of the probable words, as in the case of a spoken utterance.

At S108, the processed utterance, a string of tokens, is input to the model 38, which outputs one or more of the most probable candidate logical forms, based on the current model (S110).

If at S112, the dialog is complete, for example, all information needed to complete a task has been obtained from the user, the method proceeds to S114, where a task may be performed by task execution component 36, otherwise to S116, where the dialog manager may update one or more of the dynamic component(s) 54, 58 of the model based on the state of the dialog, and identify a next logical form 42 for generating an agent utterance (S118). The logical form is selected from the set 44 with the aim of advancing the dialog, for example, to ask a question that is responsive to the logical form of the user's utterance or to clarify or confirm what the user may have asked.

At S104, the identified logical form is input to the optionally updated model 38 and at S120 the model generates one or more of the most probable candidate agent utterances, based on the current model, which is/are output to the dialog manager (S122). If the model outputs more than one agent utterance, the dialog manager may select one and output that utterance to the user (S124). The output surface string, or a surface string derived therefrom, is sent to the user's computer for communication to the user on the computing device 20, e.g., on a display device or audibly, from a speaker, via a text to speech converter. The dialog manager may update one or more of the dynamic component(s) 54, 58 of the model based on the state of the dialog (S126), and the method returns to S102 to await a next utterance from the user.

The method ends at S128.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 26, (for example, an internal hard drive of RAM), or may be separate (for example, an external hard drive operatively connected with the computer 26), or may be separate and accessed via a digital data network such as a local area network (LAN) or the Internet (for example, as a redundant array of inexpensive of independent disks (RAID) or other network server storage that is indirectly accessed by the computer 26, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the analysis and generation method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Model for Reversibility

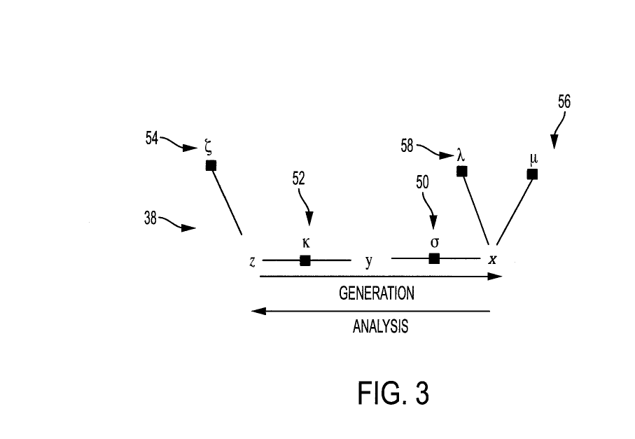

A conceptual view of the reversibility model 38 is shown in FIG. 3. It represents a probabilistic graphical model of the type described in Jordan, “Graphical models,” Statist. Sci., 19(1):140-155, 022004.

Conceptually, the reversibility model 38 involves finite-state automata and transducers not only on strings, but also on trees. However, in one practical implementation, the model 38 can be implemented using only string-based automata and transducers, and exploiting tools which are purely string-based. The illustrated reversibility model 38 is fairly general and is applicable to a variety of domains. As an example, the application domain of task-oriented dialogues is described.

The logical forms 42 are generally represented as trees. For an introduction to tree automata and transducers, see, for example, Maletti, “Survey: Tree transducers in machine translation,” Technical Report, Universitat Rovira i Virgili, 2010; and Fülöp, et al., “Weighted tree automata and tree transducers,” in Handbook of Weighted Automata, Monographs, Manfred Droste, et al, editors, Theoretical Computer Science, An EATCS Series, pp. 313-403, 2009. It is also assumed (as is actually the case) that operations such as intersection, composition and projections, can be generalized from strings to trees.

In the graphical model shown in FIG. 3, z is a logical form 42, namely a structured object which can be naturally represented as a tree, x is a surface string 28, 40 such as a sequence of tokens, and y is an underlying string 46 that corresponds to one of the small collection 60 of canonical text strings for realizing the logical form z. The Greek letters ζ, κ, σ, λ, μ correspond to factors over x, y and z, that is, to non-negative functions that collectively define a joint probabilistic distribution over x, y, and z. For ease of reference, ζ is referred to as the semantic context factor, κ as the canonical factor, σ as the similarity factor, λ as the language model factor, and μ as the language context factor. Each factor is implemented through a finite state device (acceptor or transducer) over strings or trees. The factors ζ(z), λ(x), and μ(x) are unary factors (functions of a single argument that output a real value), that are realized as weighted finite-state acceptors (also known as automata), with λ and μ being string automata, and a tree automaton. The factors κ(z,y) and σ(y,x) are binary factors (functions of two arguments that output a real value), that are realized as weighted finite-state transducers, σ(y,x) being a standard string transducer, and κ(z,y) being a tree-to-string transducer. κ can be approximated by a weighted string-to-string automaton, as discussed below.

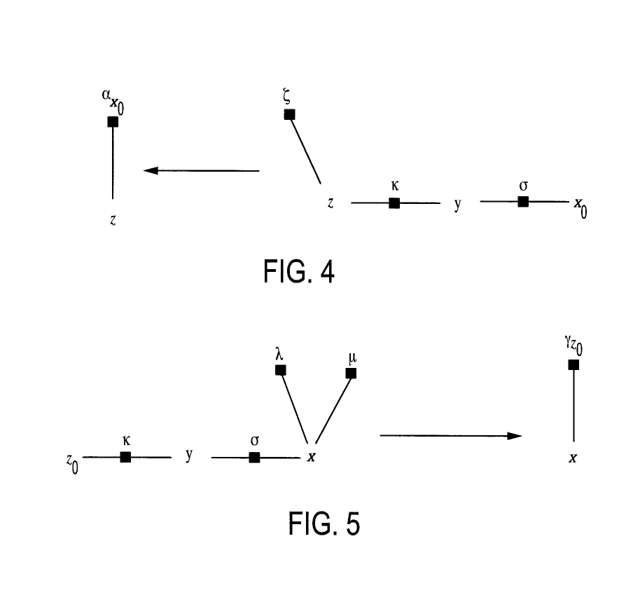

During analysis, the probabilistic model is composed as shown in FIG. 4. The probabilistic model takes as input a surface string x which is processed by the similarity factor to identify a set of similar canonical strings y (or more accurately, to construct a transducer σ(y,x), which represents a probability distribution over canonical strings as a function of y and input x). This output is input to the canonical factor κ to identify a set of candidate logical forms z corresponding to the input canonical strings (or more accurately, to construct a transducer κ(z,y) based on σ(y,x), which represents a probability distribution over logical forms as a function of z and y, given input x. The candidate set of logical forms is filtered by the semantic context factor (updated to reflect the state of the dialogue) to reduce the set of logical forms to identify one or more output logical forms z. During generation (composed as shown in FIG. 5), the probabilistic model takes as input a logical form z which is processed first by the canonical factor κ to identify a set of underlying canonical text strings y (or more accurately, to construct a transducer κ(y,z) which represents a probability distribution over canonical text strings as a function of y and z). This output is then processed by the similarity factor to identify a candidate set of surface strings (or more accurately, to construct a transducer σ(x,y), based on κ(y,z) as a function of x and y, given input z). The output is filtered by the language model factor and the language context factor to reduce the set of candidate surface strings to identify one or more output surface strings x by modifying the probabilities of the candidate surface strings. As will be appreciated, the finite state machines are composed in the order described to generate the output of the analysis or generation, as discussed in further detail below.

The language model factor λ is an automaton that represents a standard n-gram language model over surface strings x. It is static in the sense that it does not change across dialogues, n-gram language models are readily implemented as string automata. The language model factor λ generates a score for each of a set of candidate text strings x which favors strings in which the n-gram sequences are observed more frequently during the training of the language model. n can be, for example, a number such as 1, 2, 3, 4, or more.

The language context automaton μ in contrast, is a dynamic (contextual) factor. This means that it may change during the course of a dialogue. This allows taking into account changing expectations on the language to use. As an example, the language context factor μ facilitates use of vocabulary better aligned to the vocabulary of the customer, or in relation to the expertise profile of the customer. By decoupling this factor from the generic language model λ, a gain in flexibility, in terms of adapting generated text to the current, evolving, dialogue, is achieved. The μ factor may give a higher weight to a word that has been used in a prior user utterance than to an alternative word that is considered similar (aligned to a same word of a canonical text used to generate candidate surface strings x).

The language context factor μ can thus be used dynamically to advantage certain formulations over others. For example, if the customer appears to prefer the use of the term “computer” over “laptop,” then it is easy to introduce a μ that gives a smaller weight to the word laptop (e.g., less than 1) and a larger weight to the word computer (e.g., greater than 1), while keeping the weights of all other words at an intermediate weight, e.g., 1. This has the effect of orienting the generation of x, controlled by the language model factor λ, to favor one formulation over the other, and maintaining a desirable alignment between the languages of both speakers. Both λ and μ are only active during generation; during analysis, x is known, and the two factors have no influence on it.

The semantic context factor ζ is a weighted regular tree automaton that is also dynamic, and represents the contextual expectations of the dialog manager 32, relative to the next dialog act of the customer ζ may be approximated by a weighted string automaton, as described below. By instantiating this automaton, the dialog manager can, for example, communicate to the model that it has some expectations about which device will be referred to in the next customer utterance x (even if it is only mentioned implicitly or through pronominal reference). Thus, this factor is useful for orienting the analysis of x in certain contextually likely directions. The ζ factor is only active during analysis; during generation, z is known, and the factor has no influence on it.

The canonical factor κ relates logical forms z to canonical realizations y. This factor concentrates on prototypical ways of expressing a logical form in the given natural language (e.g., English), and does not attempt to cover all possible expressions of the logical form. The canonical factor κ is static and is a weighted tree-to-string transducer, which implements a relation between logical forms z and a small number of the canonical texts y realizing these logical forms. For example, κ may associate the logical form (agent dialog act) z=wad(batLife; iphone6), where wad is an abbreviation for “what is the value of this attribute on this device?”, and batLife is an abbreviation for “battery life”, with such canonical texts as: What is the battery life of the iPhone 6?, and On the iPhone 6, how long is the battery life? Generally, an utterance x from the customer will not be in the limited range of canonical texts produced by the κ factor. For example, x=What about battery duration on this iPhone 6? may not be equal to any y such that ∃zκ(z,y).

The purpose of κ(z,y) is not to directly relate all possible strings y to their logical forms z, but rather only those strings y that are considered as some kind of prototypical textual renderings of the logical form z (however with the possibility of having several such renderings for a single z).

Parsing robustness is obtained through the introduction of a similarity factor σ that establishes a flexible connection between raw surface realizations x and the latent canonical realizations y. The similarity factor σ thus has the role of bridging the gap between the actual utterances x and the canonical utterances y. This factor, which is static, is implemented as a weighted finite state transducer (a string to string transducer), which gives scores to x,y according to their level of similarity, relative to given criteria, examples of which are described below. The factor σ outputs values ranging between minimum and maximum values, such as from 0 to 1, with 0 indicating no similarity, and 1 indicating perfect similarity between x and σ. The similarity factor σ relates the two strings y and x, where y is a possible canonical utterance in the limited repertoire produced by κ, and x is an actual utterance, in particular any utterance that could be produced by a human speaker. As an example, suppose that the user's utterance is x=What about battery duration on this iPhone 6?, the goal is for this x to have a significant similarity with the canonical utterance y=What is the battery life of the iPhone 6?, but a negligible similarity with another canonical utterance such as y′=What is the screen size of the Galaxy Trend? The similarity factor serves to decouple the task of modeling possible well-formed realizations of a given logical form from the task of recognizing that a given more or less well-formed input is a variant of such a realization. In other words, the canonical factor κ(z,y) concentrates on a generation model, namely on producing some well-formed output y from a logical form z, while the similarity factor σ(y,x) concentrates on relating an actual user input x to a possible output y of this generation model. The similarity factor σ thus enables the generation model defined by κ to be employed for semantic parsing.

The similarity factor is also employed during generation to generate different candidate text strings x from the canonical form(s) y. This gives the μ factor more options to select from in matching the user's language usage and for the λ factor to promote a well-formed utterance.

The transducer σ may introduce various forms of similarity, which can be scored differently. As examples:

1. Have σ(y,x)=1 exactly in the case of y=x, meaning that identity is the best possible match.

2. Introduce synonyms and/or variable spellings for some words, e.g., with a lower weight than the exact match. For example, if x contains the word duration, then in y this could be aligned to the word to life, but with a weight smaller than 1. Similarly, variable (e.g., incorrect) spellings may be introduced for devices, and so forth.

3. Allow certain types of word swapping to allow for reordering.

4. Allow some words of x to not appear in y, but with a penalty which may depend on the semantic importance of the word. For example, if x=For the iPhone 6, what is the battery duration?, a strict requirement that the words “iPhone” and “battery” both appear in y may be imposed, with a high penalty for the question mark not appearing.

As an illustrative example, a is implemented as a weighted edit distance transducer, which is able to more or less strongly penalize mismatches (synonyms and/or variable spellings), deletions, and insertions, between x and y depending on their relative importance for the identification of the underlying semantics.

During semantic parsing, contextual effects can be accounted for by including factors that represent expectations about which logical forms are likely to be intended by a speaker, thereby helping the parser to disambiguate ambiguous inputs. This is especially relevant in the context of human-machine dialogue, in which such expectations dynamically evolve in the course of a conversation. Similarly, factors can be included that orient generator outputs towards contextually favored realizations.

### Transducers, Analysis, and Generation

The exemplary transducer-based graphical model 38, as shown in FIG. 3, supports operations such as intersection and composition. For example, it is possible to replace the two factors λ and μ by a single automaton λ∩μ representing their intersection, with λ∩μ(x)≡λ(x)μ(x). Similarly it is possible to replace the two factors κ(z,y) and σ(y,x) by a single tree-to-string transducer κ∘σ that represents their composition, with κ∘σ(z,y)≡Σ_{y}κ(z,y)σ(y,x). This transducer implements a marginalization over y of the joint potential κ(z,y)σ(y,x).

Analysis (parsing) can also be viewed as a form of composition/intersection. This is illustrated in FIG. 4. Parsing starts from a fixed x, denoted x₀. By intersections, compositions and projections of transducers, the graphical model can be reduced to a weighted finite tree automaton αₓ_{₀} over z, which corresponds to a real value. This can be represented as:
αₓ_{₀}=ζ∩Proj₁(κ∘σ(·,x₀)),

where Proj₁ is the projection of the transducer κ∘σ on its first coordinate, z. The joint potential αₓ_{₀} thus corresponds to finding z which optimizes the similarity σ between x₀ and z, applying κ to the result, and then filtering the result (computing the intersection) with ζ. The tree automaton αₓ_{₀}=is a compact representation of a probability distribution (unnormalized) over logical forms, from which a best analysis can be extracted (what is generally considered to be the optimal parse of x₀) or produce probabilistic samples. Overall, αₓ_{₀} represents the beliefs of the model over the probable logical forms, combining its a priori expectations before observing x₀ (from factor ζ) and the evidence coming from the observation of x₀.

Generation can be accounted for in a symmetrical way, and is illustrated in FIG. 5. Here the process starts from a fixed z, denoted z₀. The graphical model can then be reduced to a weighted finite tree automaton z₀ over x. This can be represented as:

γ_{z}_{₀}=λ∩μProj₂(κ∘σ(z₀,·)),

where Proj₂ is the projection of the transducer κ∘σ on its second coordinate represented by a dot (namely x).

Overall, γ_{z}_{₀} represents the beliefs of the model over the probable output strings, combining its a priori expectations over such strings before observing z₀ with the evidence coming from the observation of z₀.

### String-Based Implementation

As noted above, the conceptual model illustrated in FIG. 1 can be implemented using string-based transducers/automata, using, for example, the purely string-based OpenFST toolkit. See, Allauzen, et al., “OpenFst: A general and efficient weighted finite-state transducer library,” Proc. Ninth Int'l Conf. on Implementation and Application of Automata (CIAA 2007), Lecture Notes in Computer Science, vol. 783, pp. 11-23. Springer, 2007. It is to be appreciated that a toolkit which implements tree-based transducers may alternatively be employed, such as Tiburon. See, for example, May, et al., “Tiburon: A Weighted Tree Automata Toolkit,” Proc. 11th Int'l Conf. on Implementation and Application of Automata (CIAA), Lecture Notes in Computer Science, Vol. 4094, pp 102-113, 2006.

For simplicity, the following explanations of automata use the probability semiring, with multiplicative probabilities in the form of weights. The actual implementation in OpenFST however uses equivalent, additive weights (Log semiring), applying the transformation w′=−log w to multiplicative weights to convert them to costs. The semiring definitions in TABLE 1 are taken from Mohri, “Weighted automata algorithms,” in Handbook of Weighted Automata, Manfred Droste, et al., editors, pp. 213-254, 2009. Here x⊕ log y≡−log(e^{-x}+e^{-y}).

TABLE 1

| SEMIRING | SET | ⊕ | [symbol] | 0̅ | 1̅ |
|---|---|---|---|---|---|
| Boolean | {0, 1} | [symbol] | [symbol] | 0 | 1 |
| Probability | [symbol] ₊ ∪ {+∞} | + | × | 0 | 1 |
| Log | [symbol] ∪ {−∞, +∞} | ⊕_{log} | + | +∞ | 0 |
| Tropical | [symbol] ∪ {−∞, +∞ | min | + | +∞ | 0 |

While in the general approach described above, logical forms can be trees of any depth, some simplifying assumptions can be made to allow the factors to be implemented as string-based transducers and automata, such as:

1. All logical forms are flat (i.e., trees of depth 1), of the form:

Pred(Arg₁,Arg₂, . . . ,Argₙ).

2. Pred is a predicate symbol which is uniquely associated with a number n of arguments Argᵢ (its “arity”). Each Argᵢ has a unique type, different from the type of Argⱼ, for i≠j, and the different types are associated with disjoint classes of symbols.

The system may stores a set of predicate classes, each for a different type of dialog act, such as ask, apologize, thank, don't understand, goodbye, etc. The number n of arguments depends on the class of predicate, and can be 0, 1, or more. For example, the predicate goodbye may have 0 arguments.

As an illustration, consider the logical form ask_ATT_DEV(tt,ip5). Here the predicate ask_ATT_DEV has two arguments, respectively of type ATT (attribute) and DEV (device); tt (talk time) is uniquely identifiable as being of type ATT and ip5 (iPhone 5) is uniquely identifiable as being of type DEV.

A consequence of such assumptions is that a logical form of arity n can be represented as a string of symbols of length n+1, the first symbol being the predicate, and the remaining symbols being the arguments in arbitrary order. Thus, the logical form ask_ATT_DEV(tt, ip5) can be represented indifferently as the string: ask_ATT_DEV tt ip5 or as the string: ask_ATT_DEV ip5 tt.

This flexibility in ordering the arguments in the string representation of the logical form has significant advantages when emulating the general model 10 through string transducers, as such machines cannot easily (by contrast to tree transducers) move words across long distances. However, one issue arises when the predicate can have several arguments of the same type, for example when asking for a comparison of two devices. The method can then be extended by introducing two copies of the type DEV, one for the first argument, another for the second argument (involving two distinct copies of the corresponding symbols).

A description of how the different factors are implemented, using string automata and transducers now follows.

1. The κ Factor

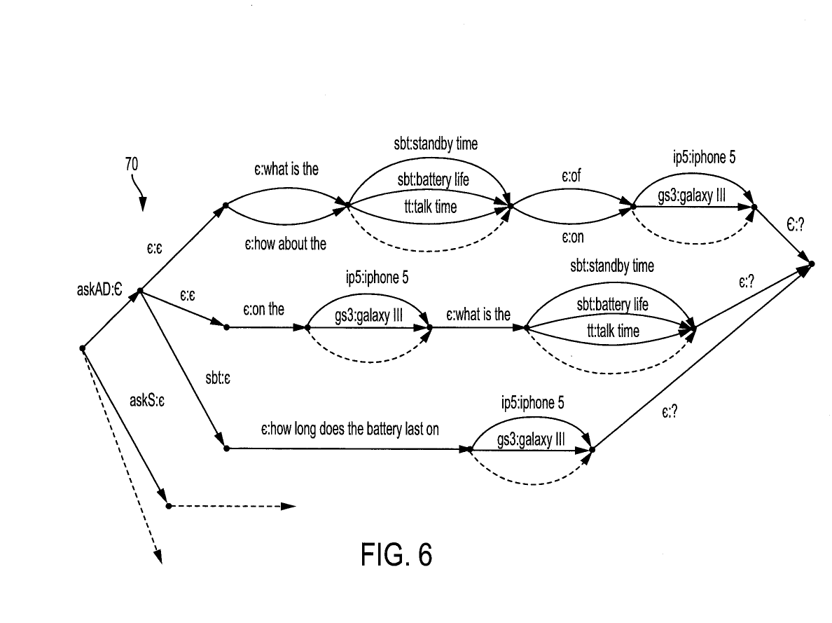

The canonical κ factor 52 can be implemented using a weighted string-to-string transducer, as illustrated in the example transducer 70 shown in FIG. 6. The separator ‘:’ divides the left side (logical form) from the right side (realization). ε represents the empty sequence, i.e., the logical form (if it appears before the colon), or the realization (if it appears after the colon), is empty for this transition. An abbreviated format is used for multiword transitions, where a transition such as “ε: how about the” actually corresponds to three elementary transitions with one word each on the right side. Each transition carries a non-negative weight, which is not shown. The symbol askAD is an abbreviation for ask_ATT_DEV, and askS is an abbreviation for ask_SYMPTOM.

The κ transducer 70 implements the relation between each possible logical form z and its canonical realizations y. For example, in FIG. 6, the logical form LF₁=askAD(sbt,ip5) is compatible with several paths p_{i,j} across the transducer, namely:

p_{1,1} askAD sbt ip5: what is the standby time of iPhone 5?

p_{1,2} askAD sbt ip5: how about the battery life of iPhone 5?

p_{1,3} askAD ip5 sbt: on the iPhone 5 what is the standby time?

p_{1,4} askAD sbt ip5: how long does the battery last on iPhone 5?

Each path p_{i,j} is associated with a weight which is obtained by multiplying the weights on the participating transitions. In general, the total weight of the paths associated with a logical form LFᵢ is Σⱼp_{i,j} and the ratio

$$\frac{{p}_{i , j}}{{Σ}_{{j}^{′}} {p}_{i , {j}^{′}}}$$

corresponds to me probability of producing the path p_{i,j} given the logical form LFᵢ, with p_{i,j}, representing any of the paths.

By projecting each generated path onto its (right side) sequence of labels, κ can be viewed as a generation device taking as input a logical form LFᵢ and generating canonical outputs y with certain probabilities proportional to the weights of the corresponding paths. Thus, in the illustration shown in FIG. 6, starting from the logical form LFᵢ, the probability of generating y=what is the standby time of iPhone 5 ? (resp. of generating y=on the iPhone 5 what is the standby time ?) is proportional to the weight of the path p_{1,1} (resp. p_{1,3}).

Thus, to generate the possible realizations of a given logical form (e.g., LF₁=askAD(sbt,ip5)) using κ, a first step may be to eliminate from further consideration all paths in κ that are not compatible with a valid permutation of the arguments of the logical form (i.e., in the illustrative example, eliminate those that are not compatible with either askAD sbt ip5 or askAD ip5 sbt), then ignore the labels (in other words, the left-hand sides of the separator ‘:’) to obtain a weighted automaton over the right side word strings. This weighted automaton Y_{LF} represents a probability distribution (unnormalized) over the canonical strings y expressing the input logical form.

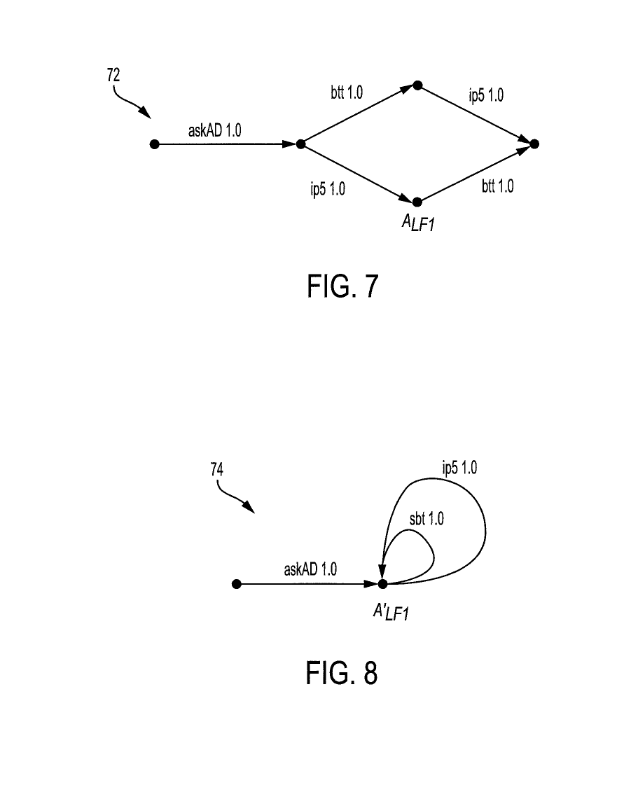

An equivalent, but more formal, description of this explanation, which will be useful for understanding the composition of ζ with κ is as follows Consider an automaton A_{LF} that respects the following property: A_{LF} gives a weight of unity to each of the valid symbol sequences representing a given (fixed) logical form LF. For LF₁, an example of such an automaton A_{LF1} 72 is given in FIG. 7 (the rightmost state being final).

Composing the automaton A_{LF1} with the transducer κ results in a transducer A_{LF1}∘κ whose left side exactly recognizes the valid permutations of LF₁, and then projecting the resulting transducer onto its right side word sequence results in the automaton Y_{LF1}=Proj₂(A_{LF1}∘κ) that represents the probability distribution over canonical realizations y generated by the logical form LF₁. The automaton A_{LF1} shown in FIG. 7 is not the only one that respects the required property. FIG. 8 illustrates another automaton 74, A′_{LF1} (where the rightmost state is final), resulting in the same Y_{LF1}.

In the case of two or more transitions that are represented by loops which return to the same point, as is the case here for ip5 and sbt, this indicates that the loops can be performed in any order. Additionally, not all loops need be performed, although the final selection is always limited to a valid permutation of the arguments of the logical form. Where, as described below, there are loops with different weights, some loops or combinations are favored over others.

2. The ζ Factor

A string-based version of the semantic context automaton ζ corresponds to the dynamic contextual expectations over which logical form is likely to be intended by the next textual input. The purpose of the ζ automaton is to represent a probability distribution over logical forms. While conceptually, as previously noted, this could be realized through a weighted finite-state tree automaton, in an exemplary embodiment, each logical form tree is represented with a collection of symbol sequences corresponding to argument permutations.

In some instances, the intended distribution over logical forms is concentrated on a single logical form, for example on LF₁. In this case, the constraints that the string automaton ζ should take are already known, as discussed above for κ: it should give unity weight to each of the valid symbol sequences representing this underlying logical form LF₁. Both automata A_{LF1} and A′_{LF1} respect this constraint, and either of them can therefore be chosen for ζ in this situation.

A generalization of the constraint, allowing ζ to represent a distribution over several logical forms is as follows: for each logical form z, ζ gives the same weight w(z) to each of the valid symbol sequences representing z. Given such a string automaton ζ, the probability that this automaton assigns to any logical form z is then defined as:

$$p ( z ) ≡ \frac{w ( z )}{{Σ}_{{z}^{′}} w ( {z}^{′} )} ,$$

where w(z) is obtained by computing the weight given by ζ to an arbitrary valid sequence representing z.

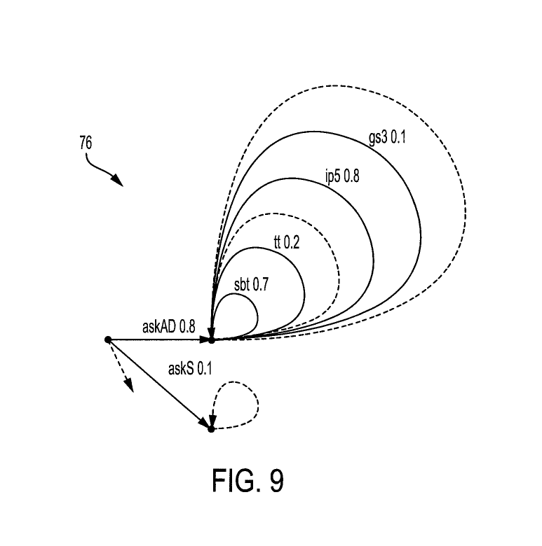

An example of such a ζ automaton 76 is shown in FIG. 9. Some symbol sequences in this automaton, such as askAD gs3 sbt ip5 are not valid, but any two valid sequences corresponding to the same logical form, for example askAD tt gs3 and askAD gs3 tt, or askAD sbt ip5 and askAD ip5 sbt, have the same weight.

The weights less than 1 that are assigned to the symbols can be manually assigned and/or learned on a labeled training set.

As discussed above, Y_{LF1}=Proj₂(A_{LF1}∘κ) is the automaton representing the (un-normalized) probability distribution over canonical realizations y generated by the single logical form LF₁. This observation also generalizes to the automaton Proj₂(ζ∘κ), which is the automaton representing the (un-normalized) probability distribution over the canonical realizations y generated by the distribution over logical forms produced by.

3. The σ Factor

In contrast to the factors κ and ζ, which conceptually involve trees but are approximated through strings in the illustrated embodiments discussed above, the similarity factor σ 50 is conceptually a string-to-string transducer, and therefore no emulation is needed. In one embodiment, the similarity factor is based on a measure of a generalized edit distance which takes into account one or more of swaps, insertions, deletions (optionally with different penalties for certain words), and replacements of tokens. Implementing edit distance through weighted string transducers has been used for applications such as speech recognition, OCR, or computational biology. See, Mohri, “Edit-distance of weighted automata,” CIAA, Lecture Notes in Computer Science, vol. 2608, pp. 1-23, 2002, but in a rather different manner.

FIG. 10 schematically illustrates an exemplary edit distance transducer 78 useful for σ. The edge denoted a:a abbreviates a number of individual transitions, namely all the transitions where the left side (i.e., left of the colon, corresponding to words of y) is any word a in a vocabulary 80, denoted V, and where the right side is the same word a. The weight assigned to all transitions a: a is w₁=1. The vocabulary V is the union of all words that can appear either in x or in y. While the words that can appear in y are by construction those that are mentioned in κ, those that can appear in x are in principle any words that the language model λ recognizes. For semantic parsing purposes, given an input x, a possible online optimization is to consider in the right side of σ only those words that actually appear in x, as all the others are inactive. The vocabulary 80 can be stored in memory 12 (as illustrated in FIG. 1) or accessed from a remote memory storage device.

In some embodiments, the vocabulary V is partitioned into two (or more) disjoint subsets 82, 84, e.g., denoted L and H, where H is a set of high salience words, and L=V \H is the complementary set of low salience words. The purpose of this distinction is that the words in H carry more task-relevant information than the words in L. The edges involving the notation h correspond to high salience words in H and those involving l, a low salience word. The edge ε:l represents all the transitions where the left side is the empty string and where the right side is a word l in L. The same weight w₂ is associated with all such transitions, which is specified as being strictly smaller than 1. Symmetrically, the set of transitions l:ε are defined with weight w′₂, again specified to be smaller than 1. For illustration, w₂=0.8 and w′₂=0.8, although different values may be assigned. Similarly, the edge ε:h represents all the transitions where the left side is the empty string and where the right side is a word h in H. The weight w₃ of this transition is specified to be strictly smaller than w₂. Symmetrically, for the set of transitions h:ε, a weight w′₃ is assigned, again specified to be smaller than w′₂. For example, w₃=w′₃=0.1.

Ignoring edge α:β for the present, the five transition classes that have been introduced so far influence the alignments produced by the transducer. In particular, it prefers to align any word a with itself, since this has the highest weight (w₁=1, meaning no penalty for the transition a:a), but that it pays a small penalty 0:8 (resp. a high penalty 0:1) for being unable to align a low salience (resp. high salience) word to the same word on the opposite side. In the case of the exemplary dialogue task domain involving smartphones, some high salience words could be words such as battery, screen, standby, time, life, talk, size, iPhone, galaxy, 1, 2, 3, 4, 5, 6, etc., and some low salience words could be words such as the, a, is, are, on, of, perhaps, can, you, how, what, my, child, office, tell, me, please, ‘,’, etc. While two saliency classes are used for illustration, more saliency classes could be provided with different weights and respective words.

Based on such definitions, and for such an input as x₁=what is the talk time of iPhone 5 ? (see FIG. 6), the best possible canonical realization (relative to the illustration in FIG. 6) would be y₁=x₁ with the σ transducer giving maximum weight to the pair (x₁,y₁), namely the weight σ(x₁,y₁)=1. In contrast, an input such as x₂=what is the screen size of iPhone 5 ? would lead to a much worse σ(x₂,y₁)=0.0001=w₂ (two deletions h:ε and two insertions h:ε), and to the optimal value 1 for y₂=x₂.

Consider now an input such as x₃=for iPhone 5 how is talk time ? No canonical realization from FIG. 6 would give a weight of 1 to this input, but the canonical realization y₃=on the iPhone 5 what is the talk time ? would be heavily favored over other canonical realizations, since it only involves deletions and insertions of the low-salience words for, the, how, on, what.

Consider now an input such as x₄=talk time ? For such input, there would be a large penalty for all the possible canonical realizations, however all such realizations containing the two high salience words talk and time would have a strong advantage over other realizations. This would mean that the composition of σ and κ would strongly favor such logical forms as askAD(tt, <DEV>), while being noncommittal about the value of <DEV>. However, in the situation where the semantic context factor ζ 54 has strong expectations about the device (<DEV>) under consideration being the iPhone 5, the overall composition with z would allow the interpretation askAD(tt, ip5) to emerge as the strongest one.

The α:β edge is used for word replacements, which is useful to account for synonymy, paraphrases, and misspellings. While such edges could be dealt with by a deletion and insertion, this has disadvantages, particularly when the inserted/deleted word is of high salience. For example consider the two expressions battery life and battery duration; assuming only the first five mechanisms described, the cost of aligning these would correspond to the product of the cost of deleting life with that of inserting duration. For such situations, it is useful to introduce specific transitions of the form α:β, with α=battery life and β=battery duration. The weight w_{αβ} for such transitions should be lower than 1 (in order to favor identical alignments) but higher than that corresponding to using the generic insertions and deletions previously described.

As will be appreciated, the similarity factor σ, and the weights used, are not limited to the examples described for the flexible edit distance transducer.

The weights, such as w₁ and w₂ can be manually selected or learned. One way is to identify a few broad classes of transitions and to assign a common weight to all the transitions in a given class; these weights could then be learnt to optimize some loss function on a small supervised development set of inputs x, each labeled with a respective logical form z.

While the illustrated examples output an agent utterance in a same natural language as a user utterance, in other embodiments, the reversible specification is used for machine translation. In this case, the collection of canonical texts 60 may include a first set of canonical texts in a first language that are used for generation and a second set of canonical texts in a second language that that are used for analysis.

### EXAMPLES

A proof-of-concept model 38 was implemented based on the open source OpenFST toolkit where the probabilities are expressed as costs, rather than as weights.

### Example 1

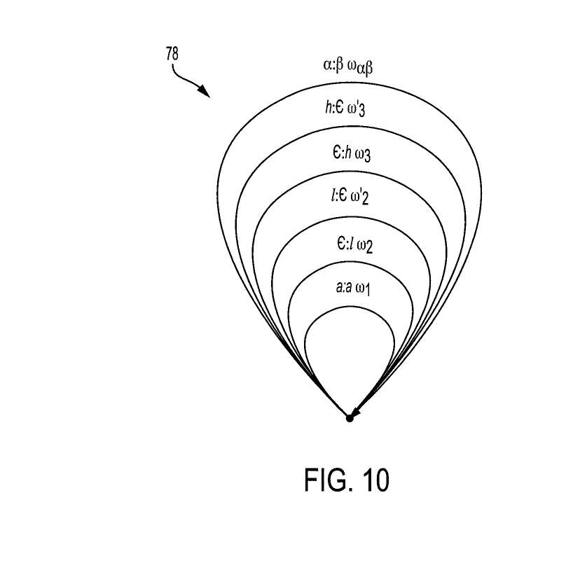

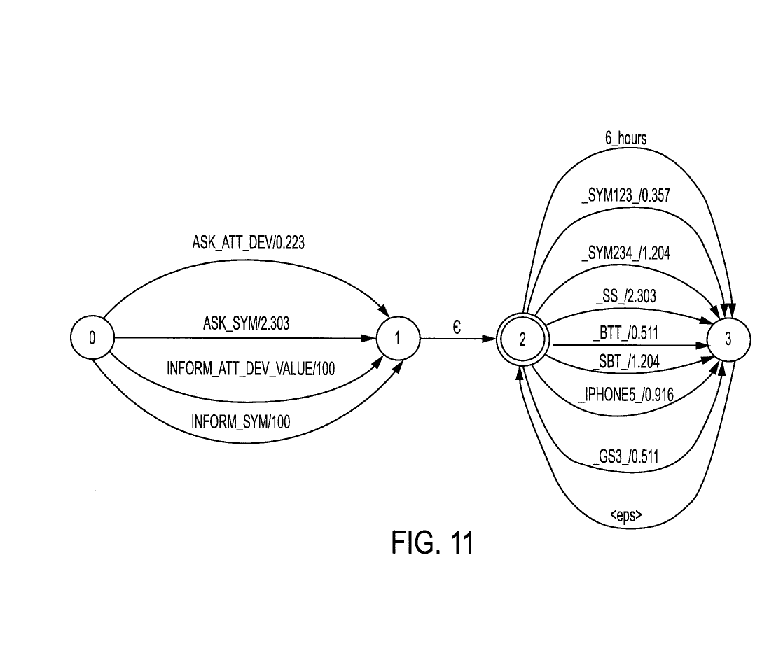

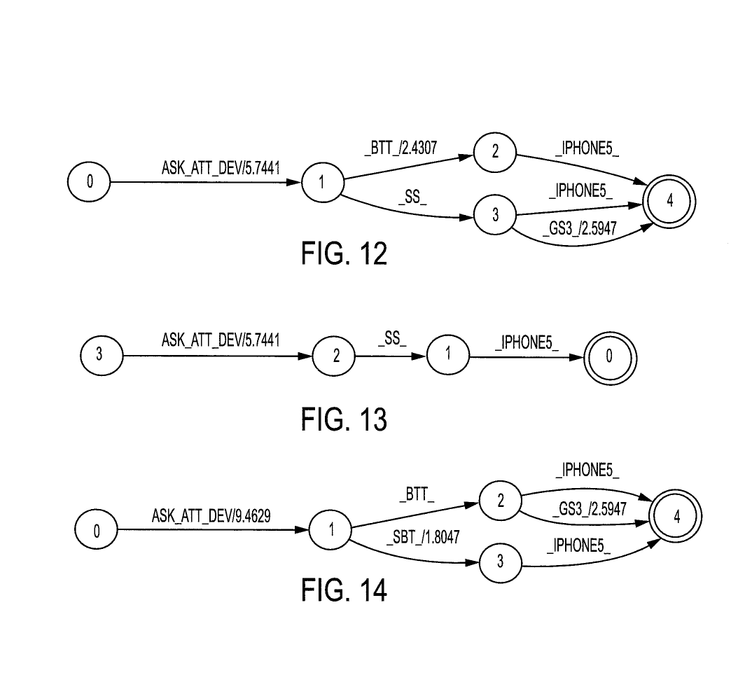

In this example, the input x is the utterance what is the screen size of iPhone 5 ?. The κ and σ transducers are of a form similar to those illustrated in FIGS. 6 and 10. The automaton ζ₁ illustrated in FIG. 11 represents the semantic expectations in the current context. This automaton is of a similar form to that of FIG. 9, but presented differently for readability: the transitions between state 2 and state 3 correspond to a loop (because of the ε transition between 2 and 3); also, the weights are here given in the tropical semiring, and therefore correspond to costs. In particular, it is observed that in this context, everything else being equal, the predicate ask_ATT_DEV is preferred to ask_SYM, the device GS3 to iPHONE5, and the attribute BTT (battery talk time) to SBT (standby time) as well as to SS (screen size), and so on. The result αₓ_{₀} of the composition (see FIG. 4) is represented by the automaton partially illustrated in FIG. 12, where only the three best paths are shown. By convention, the weight 0, corresponding to a null cost in the tropical semiring (or a weight of 1 in the prior illustrations), is not explicitly shown. The best path in αₓ_{₀} is shown in FIG. 13. It corresponds to the logical form ask_ATT_DEV(SS,IPHONE5), namely the best interpretation of what is the screen size of iPhone 5 ? in the context of ζ₁.

The canonical realization y that leads to this best path is what is the screen size of iPhone 5 ?, i.e., to be identical to x in this case. This is not a coincidence in this example, since x was chosen to be equal to a possible canonical realization.

### Example 2

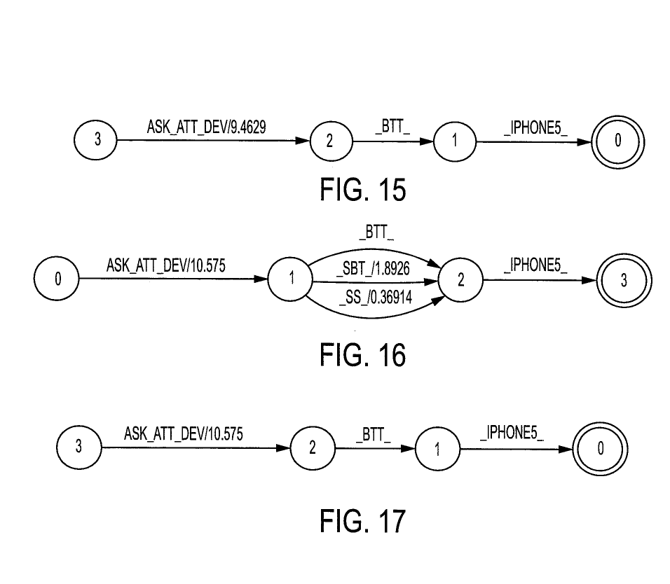

This example uses the same semantic context ζ₁ finite state machine as in Example 1, but this time with an input x equal to battery life iPhone 5. FIG. 14 shows the resulting automaton αₓ_{₀}, again after pruning all paths after the third best. The best path is shown in FIG. 15 It corresponds to the logical form ask ask_ATT_DEV(BTT, IPHONE5). In this case, the canonical realization y leading to this best path can be shown to be what is the battery life size of iPhone 5 ?. This example illustrates the robustness of semantic parsing: the input battery life iPhone 5 is linguistically rather deficient, but the approach is able to detect its similarity with the canonical text what is the battery life of iPhone 5?, and in the end, to recover a likely logical form for it.

### Example 3

This example uses the same context ζ₁ as in Example 1, but this time with an input x=how is that of iPhone 5 ? The resulting automaton αₓ_{₀} is shown in FIGS. 16 (best 3 paths) and 17 (best path). Here, the best logical form is again ask_ATT_DEV(BTT,IPHONE5), and the corresponding canonical realization y again is what is the battery life of iPhone 5 ?. This example illustrates the value of the semantic context: the input uses the pronoun that to refer in an underspecified way to the attribute BTT, but in the context ζ₁, this attribute is stronger than competing attributes, so emerges as the preferred one. Note that while GS3 is preferred by ζ₁, to IPHONE5, the fact that iPhone 5 ? is explicitly mentioned in the input enforces the correct interpretation for the device.

### Example 4

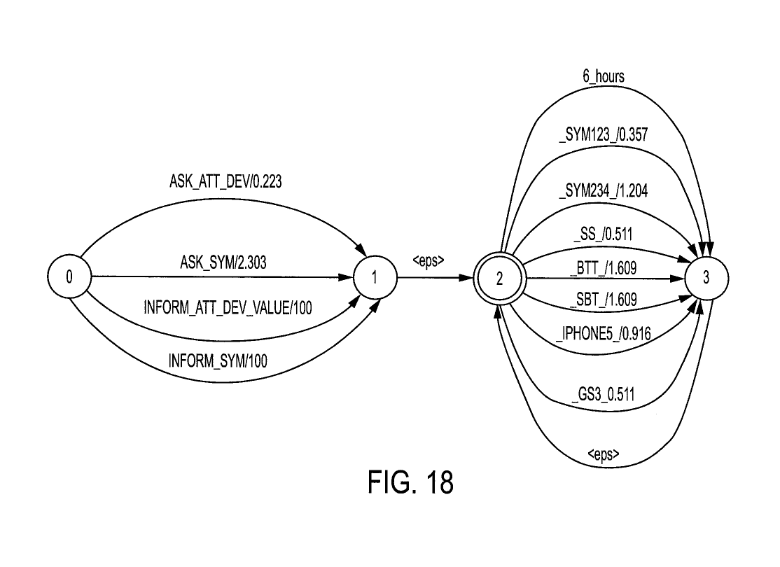

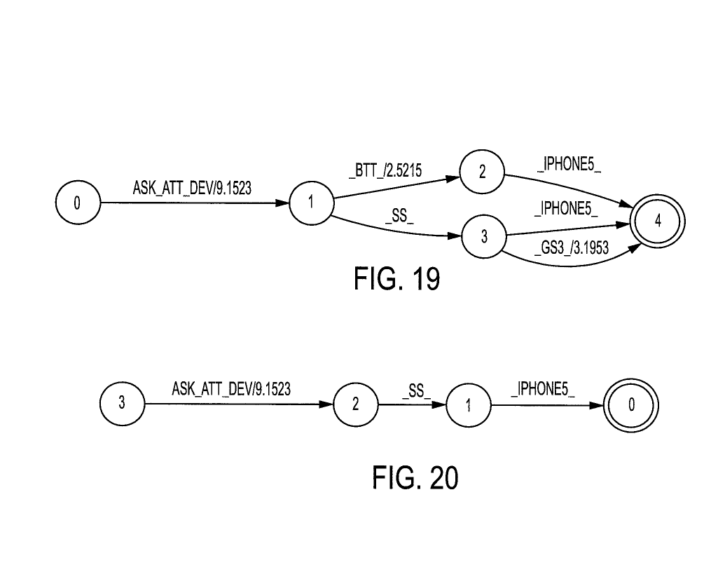

This example is the same as Example 3, again with x=how is that of iPhone 5 ?, the only difference being that this time, the semantic context is different, and is represented by the semantic-context automaton ζ₂ shown in FIG. 18. This semantic context now expects the attribute SS (with a cost of 0.511) more strongly than BTT (with a cost of 1.609). The corresponding results are shown in FIGS. 19 (best 3 paths) and 20 (best path). Now the best logical form is ask_ATT_DEV(SS,IPHONE5) and the corresponding canonical realization y is now what is the screen size of iPhone 5 ?. The difference with Example 3 is only due to the semantic context, which now prefers the attribute SS to other attributes.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of providing for analysis and generation through a same probabilistic model, comprising:
providing a reversible probabilistic model comprising a set of factors comprising:
a canonical factor which is a function of a logical form and a realization;
a similarity factor, which is a function of a canonical text string and a surface string,
a language model factor, which is a static function of a surface string,
a language context factor, which is a dynamic function of a surface string, and
a semantic context factor, which is a dynamic function of a logical form;
the reversible probabilistic model being able to perform both analysis and generation,
wherein in performing generation, the canonical factor, similarity factor, language model factor, and language context factor are composed to receive as input a logical form selected from a set of logical forms and output at least one surface string, and
wherein in performing analysis, the similarity factor, canonical factor, and semantic context factor are composed to take as input a surface string and output at least one logical form in a set of logical forms, and
wherein the performing of the analysis and generation is implemented by a processor.

2. The method of claim 1, wherein the factors are finite state machines.

3. The method of claim 2, wherein the finite state machines are string-to-string finite state machines.

4. The method of claim 1 comprising conducting a dialog with a person, in which the analysis includes generating a first logical form for an input surface string received from the person and the generation includes generating an output surface string based on a second logical form.

5. The method of claim 1, further comprising updating at least one of the semantic context factor and the language context factor during a dialog.

6. The method of claim 5, wherein the updating of the semantic context factor is based on an expectation over logical forms in the set of logical forms.

7. The method of claim 5, wherein the updating of the language context factor is based on an expectation over words output by the similarity factor which are not exact matches of aligned words in corresponding canonical text strings.

8. The method of claim 1, wherein the similarity factor computes an edit distance between the canonical text string and the surface string which takes into account one or more of swaps, insertions, deletions, and replacements of words.

9. The method of claim 1, wherein the language model factor λ(x), language context factor μ(x), and semantic context factor ζ(z) are unary factors of a candidate text string x or logical form z, respectively, that are implemented as weighted finite-state acceptors, with λ and μ being string automata, and ζ being a tree automaton.

10. The method of claim 1, wherein the canonical factor κ(z,y) and similarity factor σ(y,x) are binary factors implemented as weighted finite-state transducers, σ(y,x) being a string transducer, and the canonical factor κ(z,y) being a tree-to-string transducer, where y is a canonical string, x is a surface string, and z is a logical form.

11. The method of claim 10, wherein the canonical factor is approximated by a weighted string-to-string automaton.

12. The method of claim 1, wherein the language model factor is an automaton that represents an n-gram language model over surface strings.

13. The method of claim 1, wherein the language model factor generates a score for each of a set of candidate text strings which favors strings in which the n-gram sequences are observed more frequently during training of the language model factor.

14. The method of claim 1, wherein the language context factor is a dynamic factor that changes during the course of a dialogue as a function of input text strings.

15. The method of claim 1, wherein the semantic context factor is a dynamic factor implemented as a weighted regular tree automaton that represents contextual expectations of a dialog manager.

16. The method of claim 1, wherein the logical forms are of the form:
Pred(Arg₁,Arg₂, . . . ,Argₙ).
where Pred is a predicate symbol which is associated with a number n of arguments Argᵢ, for i=1 to n, where each Argᵢ has a unique type, different from the type of Argⱼ, for i≠j, and the different types are associated with disjoint classes of symbols.

17. A computer program product comprising a non-transitory recording medium storing instructions, which when executed on a computer, causes the computer to perform the method of claim 1.

18. A system comprising memory which stores instructions for performing the method of claim 1 and a processor in communication with the memory for executing the instructions.

19. A system for performing analysis and generation comprising:
memory which stores a reversible probabilistic model comprising a set finite state machines comprising:
a canonical finite state machine, which is a function of a logical form and a canonical text string which is a realization of the logical form;
a similarity finite state machine, which is a function of a canonical text string and a surface string,
a language model finite state machine which is a static function of a surface string,
a language context finite state machine, which is a dynamic function of a surface string, and
a semantic context finite state machine, which is a dynamic function of a logical form;
a dialog manager which inputs logical forms and surface strings to the reversible probabilistic model for performing analysis and generation,
wherein in performing generation the canonical finite state machine, similarity finite state machine, language model finite state machine, and language context finite state machine of the reversible probabilistic model are composed to receive as input a logical form selected from a set of logical forms and output at least one surface string, and
wherein in performing analysis, the similarity finite state machine, canonical finite state machine, and semantic context finite state machine of the reversible probabilistic model are composed to take as input a surface string and output at least one logical form in a set of logical forms, and
a processor which implements the dialog manager.

20. A computer implemented method for conducting a dialog comprising:
providing in computer memory a reversible probabilistic model able to perform both analysis and generation, the reversible probabilistic model comprising a set of finite state machines comprising:
a canonical finite state machine, which is a function of a logical form and a canonical text string, which is a realization of the logical form;
a similarity finite state machine, which is a function of a canonical text string and a surface string,
a language model finite state machine which is a static function of a surface string,
a language context finite state machine, which is a dynamic function of a surface string; and
a semantic context finite state machine, which is a dynamic function of a logical form;
receiving a surface text string uttered by a person;
analyzing the received surface text string, wherein in the analysis, the similarity factor, canonical factor, and semantic context factor are composed to take as input the surface string and output a first of a set of logical forms, and
selecting a second logical form based on the first logical form;
generating at least one surface string, wherein in the generation, the canonical factor, similarity factor, language model factor, and language context factor are composed to receive as input the second logical form and output at least one surface string; and
outputting one of the at least one surface string or a surface string derived therefrom for communication to the person on a computing device,
wherein the analyzing and generation are implemented by a processor.
